(19) United States
(12) Patent Application Publication
(10) Pub. No.: US 2026/0290293 A1
(43) Pub. Date: Sep. 24, 2026

(54) METHOD OF, AND A SYSTEM FOR, GENERATING A HYBRID MUSICAL WORK IN A CLOSED ECOSYSTEM

(71) Applicant: IAIAI TECHNOLOGIES LIMITED, Tulla (IE)

(72) Inventor: Michael KIELY, Tulla (IE)

(73) Assignee: IAIAI TECHNOLOGIES LIMITED, Tulla (IE)

(21) Appl. No.: 19/570,888

(22) Filed: Mar. 18, 2026

(30) Foreign Application Priority Data
Mar. 20, 2025 (IE) 2025/0112

(51) Int. Cl. G10H 1/00

(52) U.S. Cl. CPC G10H 1/0025

(57) ABSTRACT

A computer-implemented system for generating musical works comprises a stems database, a templates database, a core generator, an artificial intelligence model, and a decomposition module. The stems database stores a plurality of musical stems, each musical stem tagged with metadata describing musical attributes. The templates database stores a plurality of musical templates, each musical template defining structural parameters for combining musical stems. The core generator is configured to combine selected musical stems from the stems database, according to structural parameters of one or more musical templates, and to generate an output file. The artificial intelligence model processes the output file to generate one or more derivative outputs. The decomposition module analyses derivative outputs and extracts a plurality of derivative musical stems therefrom. The system is configured to send extracted derivative musical stems to be stored in the stems database, for use in subsequent music generation processes.

This application claims the benefit of priority to Irish Patent Application No. 2025/0112 filed on 20 Mar. 2025, the entire content of which is incorporated herein by reference.

### FIELD OF THE INVENTION

This invention relates to a method of, and a system for, generating a hybrid musical work in a closed ecosystem.

### BACKGROUND TO THE INVENTION

Those skilled in the industry recognize a significant challenge at the intersection of generative Artificial Intelligence AI and copyright law, particularly within the realm of music generation. The utilization of generative AI in creating music presents substantial difficulties in accurately identifying and enforcing copyright protections.

A primary concern is that when AI models are trained on copyrighted music, there is a risk of inadvertently generating content that infringes on the rights of artists, composers, and record labels. This can lead to disputes over ownership and potential legal claims against both the developers and users of AI-generated music.

Furthermore, while newer generative music models are being developed using licensed datasets, these datasets are often considerably smaller and less diverse compared to those employed by large technology companies. This limitation results in lower quality outputs and poses significant challenges in scaling these models to produce large volumes of high-quality music, both from a technical and licensing perspective.

It will be appreciated by those in this industry, that traditional AI-driven music generation systems can suffer from model collapse, overfitting, and a decline in originality when repeatedly training on AI-generated outputs. Over time, such iterative self-training may lead to reinforced biases, reduced diversity, and degraded musical quality. Further, existing techniques often face difficulties balancing creativity, coherence, and genre adaptability without excessive human intervention.

There is a recognized need within the industry for AI models that can generate music without closely resembling any specific copyrighted works. Existing systems that deliver AI-generated music derived from pre-existing copyrighted material generally fail to properly attribute the original artists or composers. This lack of recognition undermines the acknowledgment and respect owed to creators, potentially diminishing the incentive for future artistic endeavors. Additionally, when new works are created from combinations of existing recordings, it may be difficult to determine the contribution of individual source elements or to maintain traceability between derivative works and the original recordings.

Therefore, there is an urgent demand for innovative solutions that effectively balance the rights of musical copyright holders with the advancements in AI technologies, ensuring both the protection of creators’ rights and the continued progress of AI-driven music generation. In particular, there is a need for systems capable of organizing modular musical elements in a structured manner, enabling compatible elements to be selected and combined according to defined musical templates, while maintaining the traceability of derivative works and allowing controlled expansion of the available dataset over time.

Other existing systems may allow users to generate or modify musical compositions by combining prerecorded audio segments, applying algorithmic composition techniques, or using machine learning models trained on large datasets of music. Such systems may take an approach involving modular musical elements, referred to as stems, representing individual instrument recordings or vocal components that can be combined to form a complete musical composition.

However, these systems have disadvantages. Firstly, large datasets must often be assembled in advance to enable meaningful generative capabilities, and this can be time-consuming and resource intensive. Additionally, combining independently recorded musical elements can result in compositions lacking coherence if certain aspects (e.g., key, tempo, chord progression) are not carefully managed.

### OBJECT OF THE INVENTION

It is an object of the invention to provide a method of, and a system for, generating a hybrid musical work in a closed ecosystem, which provides the advantages and addresses some of the issues and deficiencies described above.

### SUMMARY OF THE INVENTION

According to a first aspect of the invention, there is provided a computer-implemented system for generating musical works, comprising: a stems database, configured to store a plurality of musical stems, wherein each musical stem is tagged with metadata describing musical attributes; a templates database, configured to store a plurality of musical templates, wherein each musical template defines structural parameters for combining musical stems; a core generator which is in communication with the stems database and templates database, and which is configured to combine selected musical stems from the stems database, according to structural parameters of one or more musical templates from the template database, thereby generating an output file; an artificial intelligence model, configured to process the output file generated by the core generator, and to generate one or more derivative outputs therefrom; a decomposition module, configured to analyse one or more derivative outputs generated by the artificial intelligence model, and to extract a plurality of derivative musical stems therefrom; and wherein the system is configured to send the extracted derivative musical stems to be stored in the stems database, wherein the extracted derivative musical stems are available for use in subsequent music generation processes.

This may be advantageous, since the system allows modular musical elements (stems) to be stored in a structured repository, and it allows generation of coherent musical compositions based on a selection of compatible stems according to template structures and associated metadata of the stems. Further, by providing an architecture that can analyse an initially generated file, provide a derivative output, and categorise and store derivative stems from the derivative file, this advantageously increases the repository of stems that are available for future generation, and allows for traceability of works to be maintained over successive generations, without requiring manual expansion and analysis of the dataset. This may advantageously provide a way of converting generated outputs back into reusable musical elements, forming a recursive generative system capable of expanding its own modular dataset.

In some embodiments, the musical stems and the output file are audio format files, or MIDI files.

In some embodiments, the musical stems comprises at least one of individual instrument stems and vocal content blocks.

In some embodiments, each musical stem is tagged with metadata including one or more of: tempo, key, chord progression, instrument type, and musical style. This may advantageously support generation quality of generated outputs and derivative outputs.

In some embodiments, the stems database is configured to receive and store derivative stems extracted by the decomposition module, thereby expanding the repertoire of stems available for subsequent music generation processes; and the templates database is configured to store new musical templates associated with the derivative output of the artificial intelligence model, thereby expanding the repertoire of musical templates available for subsequent music generation processes.

In some embodiments, the computer-implemented system further comprises a tags database, configured to store metadata describing musical attributes of the extracted derivative musical stems and musical templates; and, optionally, the tags database is configured to store newly identified tags or attributes associated with the derivative output. This may advantageously provide a means for maintaining records of particular types of stems and musical templates, and traceability of the derivative stems.

In some embodiments, the core generator is configured to combine compatible musical stems based on the metadata associated with each musical stem.

In some embodiments, the core generator is configured to combine selected musical stems based on an automated prompt from the artificial intelligence model.

In some embodiments, the computer-implemented system further comprises a user interface which is configured to allow a user to input preferences and upload or modify musical content, and wherein the core generator is configured to combine selected musical stems based on user preferences input via the user interface.

In some embodiments, the musical templates stored in the templates database define one or more of: chord progressions, keys, tempos, and instrumentation requirements.

In some embodiments, the core generator is configured to select musical stems, based on matching of metadata associated with said musical stems to the structural parameters defined in the musical templates, thereby providing harmonic and rhythmic compatibility between the selected musical stems.

In some embodiments, the artificial intelligence model comprises a plurality of language models arranged in a sequential chain, wherein each language model is configured to refine one or more aspects of the output file; and, optionally, the artificial intelligence model comprises at least two language models. This may advantageously allow for iterative improvement and modification of the output file as it passes through consecutive models within the chain.

In some embodiments, the computer-implemented system further comprises a feedback mechanism configured to feed an output of a final language model in the sequential chain back to a parent language model. This may advantageously provide a mechanism for ensuring continuous learning by the artificial intelligence model, minimising the risk of model collapse, and maintaining diversity of the available musical stems and elements.

In some embodiments, the plurality of language models includes: a parent language model configured to apply initial musical transformations to the output file, including one or more of adjustments to chord progressions, rhythmic structures, and dynamic variations; a first language model configured to introduce stylistic modifications to the output file, said stylistic modifications tailored to specific genres or harmonic textures; a second language model configured to refine instrumentation of the output file, to balance frequency distribution and dynamic coherence; a third language model configured to refine articulation, phrasing, and tempo variations of the output file; and a fourth language model, configured to integrate the refinements of the first, second and third language models to synthesize an adjusted audio output.

In some embodiments, the artificial intelligence model is configured to analyse musical stems to generate a creative DNA profile for each musical stem.

In some embodiments, the computer-implemented system further comprises a creative DNA profile database configured to store a creative DNA profile for each musical stem and each derivative output.

In some embodiments, the creative DNA profile database is configured to store attribution data linking each derivative output to one or more creators of the musical stems used to generate said derivative output.

These embodiments may advantageously assist with providing proper recognition and attribution to original creators of musical works, over sequential derivative outputs.

In some embodiments, the system is configured to operate within a closed ecosystem, using only musical stems generated internally by the system or musical stems uploaded by a user. By providing a closed ecosystem in which music is generated, this advantageously allows for the repository of musical stems to grow, while maintaining ethical compliance by relying solely on internally generated and user-provided content.

In some embodiments, the decomposition module is configured to associate the extracted derivative stems with metadata describing musical attributes of said derivative stems; and, optionally, the metadata associated with the extracted derivative stems comprises one or more of tempo, key, chord progression, instrument type, and musical style.

In some embodiments, the computer-implemented system further comprises an audio-to-MIDI conversion system configured to convert one or more musical stems from audio format to MIDI format.

In some embodiments, the artificial intelligence model is configured to process MIDI format musical stems to generate derivative MIDI outputs.

A second aspect of the invention provides a method for generating musical works via a computer-implemented system, the method comprising: storing, via a stems database, a plurality of musical stems, wherein each musical stem is tagged with metadata describing musical attributes; storing, via a templates database, a plurality of musical templates, wherein each musical template defines structural parameters for combining musical stems; selecting and combining a plurality of compatible musical stems from the stems database, according to one or more musical templates; generating, via a core generator, an output file; processing the generated output file, via an artificial intelligence model, in order to generate one or more derivative outputs; decomposing the one or more derivative outputs, via a decomposition module, to extract a plurality of derivative musical stems; and storing the plurality of derivative musical stems in the stems database, wherein the extracted derivative musical stems are available for use in subsequent music generation processes.

In some embodiments, the method further comprises storing derivative stems extracted by the decomposition module in the stems database, to expand the repertoire of stems available for subsequent music generation processes; and storing new musical templates associated with the derivative output of the artificial intelligence model in the templates database, to expand the repertoire of musical templates available for subsequent music generation processes.

In some embodiments, the method further comprises storing metadata describing musical attributes of the extracted derivative musical stems and musical templates in a tags database; and, optionally, storing newly identified tags or attributes associated with the derivative output in the tags database.

In some embodiments, the method further comprises combining, via the core generator, compatible musical stems based on the metadata associated with each musical stem.

In some embodiments, the method further comprises combining, via the core generator, selected musical stems based on an automated prompt from the artificial intelligence model.

In some embodiments, the method further comprises inputting, via a user interface, input preferences and, optionally, uploading or modifying musical content, via the user interface; and combining, via the core generator, selected musical stems based on user preferences input via the user interface.

In some embodiments, the method further comprises selecting musical stems, via the core generator, based on matching of metadata associated with said musical stems to the structural parameters defined in the musical templates.

In some embodiments, the artificial intelligence model comprises a plurality of language models arranged in a sequential chain, and wherein the method further comprises refining, via a plurality of language models, one or more aspects of the output file.

In some embodiments, the method comprises feeding an output of a final language model in the sequential chain back to a parent language model, via a feedback mechanism.

In some embodiments, the method further comprises: applying via a parent language model, one or more initial musical transformations to the output file, including one or more of adjustments to chord progressions, rhythmic structures, and dynamic variations; receiving, at a first language model, a modified output from the parent language model and introducing stylistic modifications to said modified output, via the first language model, wherein said stylistic modifications are tailored to specific genres or harmonic textures;

receiving, at a second language model, a modified output from the first language model and refining the instrumentation of said modified output, via the second language model, to balance frequency distribution and dynamic coherence; receiving, at a third language model, a modified output from the second language model and refining the articulation, phrasing, and tempo variations of said modified output, via the third language model; receiving, at a fourth language model, a modified output from the third language model and integrating the refinements of the first, second and third language models to synthesize an adjusted audio output, via the fourth language model; and sending the adjusted audio output to the parent language model, via a feedback mechanism.

In some embodiments, the method comprises analysing, via the artificial intelligence model, musical stems to generate a creative DNA profile for each musical stem.

In some embodiments, the system further comprises a creative DNA profile database and wherein the method comprises: storing a creative DNA profile for each musical stem and each derivative output in the creative DNA profile database; and, optionally, storing attribution data in the creative DNA profile database, wherein said attribution data links each derivative output to one or more creators of the musical stems used to generate said derivative output.

In some embodiments, the method comprises generating, via the core generator, the output file using only musical stems generated internally by the system or musical stems uploaded by a user.

In some embodiments, the method comprises associating, via the decomposition module, extracted derivative stems with metadata describing musical attributes of said derivative stems.

In some embodiments, the method comprises converting one or more musical stems from an audio format to a MIDI format, via an audio-to-MIDI conversion system; and, optionally, processing MIDI format musical stems to generate derivative MIDI outputs, via the artificial intelligence model.

According to a third aspect of the invention, there is provided a method for generating a hybrid musical work via a computer system, the method comprising one or more of the following steps:

recording one or more instrumental stems using structured musical templates;

selecting one or more of the recorded instrumental stems to combine into a coherent musical work;

feeding the resulting musical work and the original instrumental stems into a generative Artificial Intelligence AI model; and

upon the AI model combining the resulting musical work and the original instrumental stems into a novel derivative work, reintroducing the novel derivative work into the AI model iteratively, thereby facilitating continuous learning and improvement of the AI model, to generate a hybrid musical work with ongoing refinement.

In a preferred embodiment, the generative Artificial Intelligence AI is provided in the form of an automated language model (LM) model.

In one embodiment, the recorded instrumental stems are created by having one or more human musicians capture high-quality individual instrumental recordings. These recordings are produced according to specific parameters outlined in one or more structured musical templates. Each structured musical template dictates key, tempo, and chord progression, ensuring that each musician adheres to a consistent musical structure during recording. When all stems associated with a given structured musical template are combined, they form a cohesive musical composition that is harmonically and rhythmically aligned.

According to a further embodiment of the invention, the method includes the step of incorporating a multi-stage daisy-chain learning system to enhance the iterative AI model training process. Instead of a single AI model repeatedly training on its own outputs, multiple language models (LMs) are utilized, each specializing in distinct aspects of musical composition, before looping the final output back into the first model. This structured approach mitigates the risks of model collapse, prevents loss of musical diversity, and maintains originality in generated outputs. By distributing musical refinements across multiple specialized LMs, the system ensures a balanced progression in harmonic structure, style adaptation, and overall musical complexity with minimal human intervention.

In this embodiment, the method further includes processing the generated musical work through a sequential chain of at least two and preferably at least four language models (LMs), wherein each LM specializes in distinct musical refinements such as harmony, instrumentation, dynamics, genre styling, or other attributes. Each LM takes input from the previous model, applies enhancements, and then passes the refined output forward to the next model in the sequence.

While at least four language models (LMs) provides excellent results, using just at least two language models can achieve very good results within the scope of the invention.

In this embodiment, the method further includes employing a core generator that is independent of artificial intelligence, to ensure musical integrity by generating initial structured outputs based on predefined rules, templates, and real human-recorded stems.

In this embodiment, the method further includes implementing a loopback mechanism wherein the final LM's output is fed back into the first LM in the sequence, thereby forming a closed-cycle training system that prevents model degradation and enables sustained self-improvement in AI-generated compositions.

In this embodiment, the method further includes applying an adaptive scaling and quality control mechanism to evaluate intermediate AI-generated outputs before reintegrating them into the training cycle. This quality control method allows for automated or human review of generated outputs, filtering out sub-optimal results to ensure that only high-quality musical refinements contribute to subsequent AI training iterations.

In an embodiment of the invention, each instrumental stem recorded by a musician is treated as an instrument content block. Each instrument content block represents one of a variety of instruments, such as guitar, drums, bass, keyboard, or the like. These instrument content blocks form the core building units used to generate the final hybrid musical work.

In this embodiment, each instrumental stem is embedded with comprehensive metadata, including information such as the identity of the performer, the instrument used, the recording parameters, and the corresponding structured musical template used. This tagging facilitates accurate matching to the appropriate musical template and musical style.

In this embodiment, the method includes determining a musical style such as pop, reggae, or synth for the musical work. The method further includes selecting a subset of instrument content blocks from the group of instrument content blocks based on the determined musical style.

In this embodiment, the method includes configuring the musical style by dividing it into multiple musical slots, such as verses or choruses. Each musical slot is assigned specific predetermined musical rules that define the structural and stylistic parameters guiding the creation of the musical work. This foundational framework ensures consistency and coherence throughout the musical composition.

In this embodiment, the method involves applying the predetermined musical rules to each musical slot to select an appropriate musical template from a diverse set of available templates. For every defined slot, the associated rule is used to identify a musical template that specifies a chord progression, key, and tempo consistent with the overall musical style. This ensures that each section of the musical work adheres to the established rules, resulting in a harmonically aligned and stylistically coherent composition.

In another embodiment, an instrument content block is selected for each musical slot based on the chord progression defined by the selected musical template, ensuring that each selected instrument content block corresponds harmoniously with the musical template. The system matches one or more instrument content blocks, such as guitar riffs, drumbeats, or other stems, to the musical style and templates chosen. The system then combines all selected instrument content blocks into a final track, ensuring harmonic compatibility without requiring manual or AI-based post-processing to align the recordings.

In these embodiments, the musical work is generated by combining the selected subset of instrument content blocks, resulting in a cohesive and harmonically aligned musical work.

In an embodiment of the invention, the method further includes attributing a musical work created through use of the method to each original musician or composer of each individual instrumental stem used in the musical work, regardless of whether the musical work was created with or without the AI model.

In this embodiment, the method further includes comparing the unique identifiers of instrumental stems to a database of previously recorded or disallowed combinations. If a particular identifier combination exists in the records, the method withholds generating a musical output for that combination. Conversely, if no such record exists, the method combines the selected instrument stems to create a new musical output file. After generating a musical output file, the method includes storing a record of the combination of unique identifiers associated with the instrumental stems used, ensuring a traceable history of all combinations employed in producing musical output files.

In this embodiment, the method includes accommodating one or more vocals by isolating the vocal track, if present. This isolation enables the user to replace or rearrange instrumental stems around the preserved vocal content. Additionally, the method includes automatically detecting the style of the vocals or the overall song, generating compatible new instrumental stems accordingly.

In a further embodiment, the method includes processing instrumental performances and instrumental stems uploaded by a user by analysing them to determine the appropriate musical style and then rebuilding the music with selected pieces that maintain the original feel. Newly selected blocks seamlessly replace existing ones, generating a fresh version of the musical track.

In this embodiment, new recordings of vocals or instruments are integrated into the musical output file in real time. The method includes enabling users to apply effects such as reverb, delay, pitch correction, or compression. These user-generated elements can be copied or reused across multiple sections of the track to enhance consistency and creativity.

In this embodiment, the method includes a visual interface that allows users to drag, drop, swap, or edit instrument content blocks. A backend process manages the logic for combining these blocks and ensures their compatibility with the relevant musical templates. Additionally, an optional proprietary AI language model may generate additional music content or synthetic training data based solely on approved, human-created instrumental stems.

In this embodiment, the method incorporates advanced tools such as a shuffle or replace function for specific parts of an instrumental stem, such as a guitar riff. It also supports multimedia integration, enabling synchronization of audio with images or videos. Furthermore, the method offers web or third-party integration via an Application Programming Interface (API), allowing broader development of client applications. Users can create music projects directly in a web browser or embed the method’s functionality into other software platforms.

In this embodiment, instrument and vocal content blocks are treated as flexible units within the method. Some instrument blocks, like drum loops, lack a specific pitch or key and are thus considered universal. Vocal blocks are assigned detailed tags for tempo, key, and phrasing, enabling their use across multiple templates or song arrangements for remixes or alternative versions.

In this embodiment, the method supports advanced music editing capabilities, including key transposition, song-structure customization, muting or editing specific sections, and creating mashups by combining elements from different templates. The method can automatically adjust tempo and pitch or swap content blocks to maintain musical consistency throughout the composition.

In this embodiment, template and section customization within the method are subdivided into four (4) or eight (8) bar segments. Users can rearrange these segments to reconfigure verses, choruses, or bridge sections. The method can also automate genre-specific features, such as establishing a verse-chorus-verse arrangement for pop music, ensuring that the musical structure adheres to genre conventions.

In this embodiment, users interact with the method in real time to change the key and tempo or experiment with new chord progressions. The user-friendly interface allows for visual manipulation of these settings, providing instant preview and playback to facilitate iterative experimentation and creative exploration.

In this embodiment, the method blends multiple musical templates within a single track, transitioning between them in a musically cohesive manner. Integrated editing features enable users to adjust pitch or tempo, reorder sections, or selectively mute instrument content blocks, ensuring a seamless and harmonious final musical work.

In this embodiment, the method is applied in various practical contexts, including music production, remixing or adaptation of existing songs, educational tools for teaching music composition or arrangement, and broader media creation such as background music for videos, advertisements, or social media. Users can store, share, or export generated content as needed for these applications.

In this embodiment, alternative instrument block management within the method relies on analysing existing content to determine the appropriate musical style. The method automatically replaces certain instrument blocks with new ones that ensure consistent output. Additionally, the method offers audio recording and signal processing tools for newly recorded vocals or instrument performances, applying effects like reverb, delay, or pitch correction to achieve a polished sound.

In this embodiment, the method utilizes a partially open-source API, permitting third parties to expand the method’s logic within their own platforms. A core music creation module, referred to as the “musical output file generator,” acts as a central hub. It obtains input from the user or from databases of styles and templates and can integrate visuals such as artwork or videos to enhance the musical output.

In this embodiment, content block tagging and reusability within the method are enhanced by assigning “universal” tags to pitch-less instrument blocks and more detailed tags to vocal blocks (e.g., tempo, key, chord progression). This tagging system enables seamless rearrangements, remixes, or new compositions. Additionally, mash-up features allow users to import audio files, adjust them to the correct key or tempo, and mix or match sections from different sources to create unique musical works.

In this embodiment, the method includes template and section customization by dividing templates into discrete parts that users can rearrange or remove. Automated or manual key adjustments can be applied to match a vocalist’s range or desired style. This approach facilitates user-friendly manipulation, allowing changes to pitch, tempo, or track structure in real time with ease.

In this embodiment, the method is implemented via software running on general-purpose computers or specialized hardware equipped with processors, memory, and interactive displays. It operates in both desktop and mobile environments, making it suitable for various music production workflows, remixing and adaptation processes, educational programs, and broader media creation pipelines.

In this embodiment, the method includes utilizing a proprietary dataset comprising human-created music stems and all music tracks generated by the core music generation system. This exclusive use of a proprietary dataset ensures that no external copyrighted material is incorporated into the music generation process, thereby eliminating the risk of copyright infringement and the need for external licensing.

In this embodiment, the method incorporates an adaptive learning process wherein user-generated content is integrated into the AI model’s training data. This iterative feedback loop enables the AI model to continuously refine and enhance its music production capabilities, aligning more closely with individual creative preferences and current music trends. As a result, the AI model produces increasingly sophisticated and personalised musical outputs over time.

In this embodiment, the method employs an iterative feedback mechanism whereby the AI model autonomously generates original music tracks by processing and manipulating the proprietary dataset and user-generated content. This ongoing process facilitates the continuous learning and improvement of the AI model, ensuring that each subsequent musical output is more refined and tailored to user preferences without relying on external data sources or licensing agreements.

In this embodiment, the method includes providing users with the option to enable the system to create a random arrangement within the chosen musical style. This random arrangement adheres to the predefined musical rules and templates, ensuring that the generated musical output remains harmonically compatible and stylistically consistent.

In this embodiment, the method includes an interface that allows users to directly select specific instrument content blocks from a graphical user interface. This direct selection empowers users to personalize their musical output by choosing preferred instrumental elements, enhancing creative control over the final composition.

In this embodiment, the method includes the capability for users to import external audio files into the system. The method analyses these imported files to identify compatible sections that can be integrated with existing musical templates, facilitating the creation of unique mashups by combining elements from disparate sources.

In this embodiment, the method includes automatically adjusting the tempo and pitch of selected instrument content blocks to align with the musical template’s defined parameters. This automation ensures seamless integration of diverse instrumental elements, maintaining musical consistency without requiring manual adjustments by the user.

In this embodiment, the method provides users with real-time preview and playback functionality. As users manipulate musical settings, such as changing the key, tempo, or swapping instrument content blocks, the system instantly generates a preview of the musical output, allowing users to hear changes in real time and make informed adjustments.

In this embodiment, the method allows users to apply custom effects to individual instrument content blocks or entire sections of the musical output. Effects such as reverb, delay, pitch correction, and compression can be applied manually by the user, enabling personalised sound shaping and enhancing the overall quality of the musical work. For example, users can add a reverb effect to a chorus section while keeping the verse section dry, allowing for dynamic contrast and enhanced musical expression within the same track.

In this embodiment, the method includes incorporating transitional elements when blending multiple musical templates within a single track. These transitional elements ensure that changes between different templates (e.g., from a verse to a chorus) are smooth and musically coherent, enhancing the overall flow of the musical work.

In this embodiment, the method allows users to create and export their own musical templates. Users can define custom chord progressions, keys, tempos, and musical rules, saving these templates for future use or sharing them with other users. This feature promotes creativity and allows for the expansion of the system’s template library.

In this embodiment, the method includes a version control feature that allows users to save and manage different versions of their musical outputs. Users can revert to previous versions, compare changes, and maintain a history of their creative process, facilitating experimentation and iterative improvement.

In this embodiment, the method includes support for integrating external Musical Instrument Digital Interface (MIDI) controllers. Users can connect MIDI devices to the system to input musical content blocks or manipulate existing ones in real time, providing a tactile and interactive experience for music creation.

In this embodiment, the method integrates music creation with video editing and social media sharing within a single application. The system enables users to import or edit video content using built-in video editing tools such as trimming, cutting, and applying visual effects. The generated music is automatically synchronized to the video timeline, ensuring harmonious integration of audio and visual elements.

Once the project is finalized, users can publish and share their music-video creations directly within the app's integrated social media platform. This platform facilitates community engagement by allowing users to like, comment, and follow other creators. The social media integration enhances the user experience by combining music generation with interactive sharing, providing a unique and valuable tool for content creators. Additional functionalities include tracking engagement metrics, collaborating on projects with other users, and ensuring all shared content adheres to ethical guidelines and copyright compliance. These features collectively make the system a comprehensive solution for AI-driven music composition, multimedia creation, and social media interaction.

In an embodiment, the method provides flexibility in the format of output files. The audio output files, including vocal content blocks, instrument content blocks, audio input files, and audio output files, are understood to be received, stored, or recorded files containing audio or MIDI data. These files produce sound when processed by an audio or MIDI player. The method supports various audio formats, including WAV, MP3, Advanced Audio Coding (AAC), Ogg, and other analogue or digital formats as required. Users may optionally specify their desired audio or MIDI format through the user interface. Additionally, derivative outputs generated by the AI language model (LM) are provided in multiple formats, including MIDI, ensuring compatibility with a wide range of audio and music production tools.

In an embodiment, the method allows users to specify their preferred audio or MIDI formats for both original and derivative outputs. Users can select from a range of supported formats through an intuitive user interface, ensuring that the output files meet their specific needs and compatibility requirements with various audio and MIDI players. This customization capability enhances the versatility and user-friendliness of the system, accommodating diverse user preferences and technical specifications.

In an embodiment, the method includes automated synchronization of generated music with video content. The system ensures that audio elements are seamlessly integrated into the video timeline without manual adjustments, providing a smooth and efficient workflow for users. This automation enhances the efficiency of the content creation process, allowing users to focus on creative aspects rather than technical synchronization tasks.

In an embodiment, the method incorporates a social media platform within the application that allows users to publish and share their music-video creations. The platform supports interactive features such as liking, commenting, and following other users, fostering a vibrant community of content creators. This integration promotes user engagement and collaboration, enhancing the overall value and appeal of the system.

In an embodiment, the method ensures that all shared content adheres to ethical guidelines and copyright compliance. The system verifies that audio and visual elements used in music-video creations are properly licensed or original, preventing unauthorized use of copyrighted material. This feature safeguards both the users and the platform, maintaining legal and ethical standards in content sharing.

In an embodiment, the method includes tools for tracking engagement metrics such as likes, shares, comments, and follower growth within the social media platform. Additionally, the system supports collaborative features that allow users to work together on music-video projects. These functionalities provide valuable insights and foster collaborative creativity, enhancing the user experience and promoting community growth.

The method for generating a hybrid musical work via a computer system encompasses a comprehensive set of steps and features that leverage structured musical templates, user interactions, advanced AI models, and integrated multimedia tools. By providing flexible output file formats and integrating music creation with video editing and social media sharing, the system produces cohesive, harmonically aligned, and personalized musical outputs. The detailed descriptions and embodiments provided herein illustrate the versatility and robustness of the invention, making it applicable across various contexts such as music production, remixing, education, multimedia creation, and social media engagement.

In one embodiment of the invention, the method includes enabling third parties, such as record labels, artists, and rights holders, to upload their copyrighted or artistic works into the system. Each uploaded work is processed to create a unique profile, which is then securely stored in a dedicated database for future reference. By establishing this database of profiles, the system preserves essential identifiers and attributes of the original works, facilitating accurate lineage tracking and attribution.

In this embodiment, the method further includes comparing any newly uploaded or existing derivative work, including those generated by third-party AI platforms, against the dedicated database of unique profiles. The system identifies creative lineage that links the derivative work to an original copyrighted work, without requiring that the AI model responsible for generating the derivative work be trained on encrypted data or the unique profiles. This ensures that detection of unauthorized usage remains robust, independent of the AI platform’s internal training methods.

In this embodiment, the derivative works may comprise songs, audio stems, or MIDI files generated by external AI platforms such as Suno™, Udio™, or other generative AI systems. By accommodating a variety of file formats and sources, the invention maintains flexibility and scalability in detecting creative overlaps.

In this embodiment, the method further includes notifying the rights holder whenever the system detects a match between a derivative work and a stored unique profile. This allows the rights holder to track and manage any unauthorized use of their copyrighted material within a closed or partially open ecosystem, thereby strengthening copyright enforcement and offering streamlined control over potential infringement issues.

In this embodiment, detecting creative lineage is accomplished through an analytical process configured to identify creative overlaps and patterns within the derivative works, regardless of the third-party AI platform’s training methodology or dataset. Such post-generation analysis preserves the system’s independence from external training procedures, ensuring accurate copyright protection and reliable identification of original content across diverse generative AI workflows.

In one embodiment of the invention, the method includes the step of incorporating a dual-input approach by combining traditional audio stems with a parallel stream of MIDI data. Initially, one or more audio stems are converted into corresponding MIDI files through an advanced audio-to-MIDI transcription algorithm. In this embodiment, the algorithm captures note pitch, velocity, timing, and/or duration for each audio stem, creating a collection of MIDI files stored in a MIDI stems repository. The repository assigns metadata linking each MIDI file to its original audio stem, preserving a clear lineage for copyright and attribution purposes.

In this embodiment, the method includes the step of the language model (LM) processing the MIDI files alongside the audio stems. In this embodiment, through iterative training and user feedback, the LM learns to reassign harmonic structures, chord progressions, and rhythmic elements, generating derivative MIDI files that blend diverse musical styles or templates. Additionally, MIDI files derived from unrelated stems can be combined, synchronized, and harmonically aligned to create cohesive new compositions. These new MIDI-based works are then fed back into the LM for further refinement.

In terms of this embodiment, once final MIDI files are created, they can be rendered into high-quality audio using a variety of sound generators, sample libraries, or virtual instruments. This flexible rendering process enables extensive customization by the user, such as selecting new instrument sounds, applying alternative mixing effects, or shifting the overall style or genre. The resulting system thus harmonizes the efficiency of AI-driven music generation with the creative control afforded by MIDI manipulation, ensuring consistency, musicality, and proper copyright traceability across all derivative works.

According to a fourth aspect of the invention, there is a provided a computer-implemented system for generating a hybrid musical work, comprising:

a user interface device configured to allow a user to input preferences and upload or modify audio content,

a core generator configured to combine selected instrumental stems from a stems database based on the user’s preferences or automated prompts from an Artificial Intelligence AI model, thereby generating an audio output file,

an AI model configured to process the audio output file and the original stems to generate new derivative outputs,

a stems database configured to store individual instrument stems and vocal content blocks, each tagged with metadata including tempo, key, and chord progression,

a templates database configured to store musical templates associated with each derivative output, defining specific chord progressions, keys, and tempos,

a tags database configured to contain tags describing the musical attributes of each stem and template, facilitating accurate matching and retrieval,

a creative DNA profiles database configured to maintain profiles that attribute each derivative output to original creators, and

a song catalogue database configured to provide comprehensive musical references, including various musical styles and specific genres,

wherein the system operates to generate a hybrid musical work by recording instrumental stems using structured musical templates, selecting and combining stems into a musical work, feeding the work into the AI model to generate derivative works, and iteratively improving the AI model through reintroduction of derivative works.

In an embodiment of the invention, the core generator is further configured to ensure that the combination of selected instrumental stems results in a harmonically and rhythmically coherent musical work without requiring manual or AI-based post-processing.

In an embodiment of the invention, the computer-implemented system further comprises a social media integration module configured to allow users to share their generated musical works and music-video compositions directly to social media platforms, thereby fostering community engagement and collaboration.

In an embodiment, the computer-implemented system further comprises a multi-stage daisy-chain learning system to enhance the iterative AI model training process. Instead of a single AI model repeatedly training on its own outputs, this system utilizes multiple language models (LMs), each specializing in distinct aspects of musical composition, before looping the final output back into the first model. This structured approach mitigates the risks of model collapse, prevents loss of musical diversity, and maintains originality in generated outputs. By distributing musical refinements across multiple specialized LMs, the system ensures a balanced progression in harmonic structure, style adaptation, and overall musical complexity with minimal human intervention.

In this embodiment, the computer-implemented system further comprises:

a core generator (non-AI), as described in prior embodiments, ensuring musical integrity by generating initial structured outputs based on predefined rules, templates, and real human-recorded stems,

a sequential chain of at least four language models (LMs), each specializing in distinct musical refinements such as harmony, instrumentation, dynamics, genre styling, or other attributes. Each LM takes input from the previous model and enhances it before passing it forward,

a loopback mechanism, where the output of the final LM is fed back into the first LM.

This continuous closed-cycle training prevents model degradation and enables sustained self-improvement in AI-generated compositions, and

an adaptive scaling and quality control method that allows automated or human review of intermediate outputs, filtering out sub-optimal results before reintegrating them into the training cycle.

In an embodiment of the invention, the computer-implemented system further comprises visual interface configured to allow users to drag, drop, swap, or edit instrument content blocks, wherein a backend process manages the combination logic to ensure compatibility with the relevant musical templates.

In an embodiment of the invention, the AI model is configured to employ an iterative feedback mechanism to autonomously generate novel music tracks by processing and manipulating the proprietary dataset and user-generated content, thereby continuously refining the system's music generation capabilities without relying on external data sources or licensing agreements.

In an embodiment of the invention, the computer-implemented system further comprises a programming interface (API) configured to enable third-party applications to integrate with and utilize the system’s music generation functionalities, thereby broadening its applicability in diverse creative and commercial contexts.

In an embodiment of the invention, the song catalogue database is configured to include a repository of musical styles and genres that are referenced by both the core generator and the AI model to inform the selection and combination of instrumental stems and musical templates, ensuring consistency with the selected musical style.

In an embodiment of the invention, the computer-implemented system further comprises a version control feature configured to allow users to save and manage different versions of their musical outputs, enabling users to revert to previous versions, compare changes, and maintain a history of their creative process, thereby facilitating experimentation and iterative improvement.

According to a fifth aspect of the invention, there is provided a computer-readable medium for storing instructions that, when executed by a computer, cause the computer to perform the steps of:

recording one or more instrumental stems using structured musical templates, each template defining parameters such as key, tempo, and chord progression,

selecting one or more of the recorded instrumental stems to combine into a coherent musical work, wherein each selected stem corresponds to a predetermined musical slot and adheres to associated musical rules,

feeding the resulting musical work and the original instrumental stems into a generative artificial intelligence AI model,

receiving from the AI model a novel derivative work that combines the resulting musical work and the original instrumental stems, and

reintroducing the novel derivative work into the AI model iteratively, thereby facilitating continuous learning and improvement of the AI model to produce a continuously improved hybrid musical work.

In this embodiment, the instructions further cause the computer to:

embed comprehensive metadata in each instrumental stem, including information such as the identity of the performer, the instrument used, the recording parameters, and the corresponding structured musical template,

determine a musical style from a group consisting of pop, reggae, and synth for the musical work,

configure the musical style by dividing it into multiple musical slots, each assigned specific predetermined musical rules defining structural and stylistic parameters,

apply the predetermined musical rules to each musical slot to select an appropriate musical template from a plurality of musical templates, each template specifying a chord progression, key, and tempo consistent with the overall musical style,

select an instrument content block for each musical slot based on the chord progression defined by the selected musical template, ensuring harmonic correspondence with the template, and

attribute the musical work to each original musician or composer of each instrumental stem used in the musical work.

In an embodiment, the instructions cause the computer to implement a multi-stage daisy-chain learning system to enhance AI-driven music generation by processing musical outputs through multiple sequential language models (LMs), each specializing in distinct aspects of musical refinement.

In this embodiment, the instructions further cause the computer to:

receive structured musical outputs generated by a core generator at a first stage of the daisy-chain learning system, wherein the core generator ensures musical integrity by structuring compositions according to predefined templates, harmonic rules, and real human-recorded stems,

process the structured musical output through a sequential chain of at least four language models (LMs), wherein each LM incrementally refines different aspects of the composition, including harmony, instrumentation, dynamics, or stylistic variations,

utilize a loopback mechanism wherein the final LM's output is fed back into the first LM in the sequence, thereby forming a closed-cycle training loop that prevents overfitting, maintains diversity, and improves the quality of AI-generated compositions over successive iterations,

apply an adaptive scaling mechanism that dynamically modifies the number of LMs in the sequence based on computational efficiency, complexity of the composition, and desired stylistic variation,

incorporate a quality control system that automatically or manually evaluates intermediate AI-generated outputs before reintroducing them into the daisy-chain learning cycle, ensuring that only high-quality refinements contribute to subsequent training iterations,

distribute computational load across multiple LMs, optimizing processing efficiency and reducing latency during real-time music generation while maintaining musical coherence and style consistency,

provide an interface for users to customize the daisy-chain learning parameters, allowing users to adjust the weighting of harmonic refinements, instrumental variations, or stylistic attributes to tailor AI-generated compositions to specific creative goals,

enable dynamic adaptation of the AI model's learning process by selectively freezing, updating, or fine-tuning individual LMs in the chain, ensuring that certain aspects of musical refinement remain stable while others evolve in response to iterative feedback, and

ensure that compositions generated by the daisy-chain learning system maintain a balance between creative AI-driven refinements and adherence to structured musical integrity as initially established by the core generator and predefined templates.

### BRIEF DESCRIPTION OF THE DRAWINGS

These and other features of this invention will become apparent from the following description of one example described with reference to the accompanying drawings in which:

FIG. 1 shows a system for generating a hybrid musical work via a computer system, in accordance with an aspect of the invention;

FIG. 2 shows a multi-stage daisy-chain learning system for automated music generation and iterative AI refinement, in accordance with another embodiment of the invention;

FIG. 3 shows a system for integrating styles and slots with user inputs, in accordance with an aspect of the invention;

FIG. 4 shows a simplified version of a song analyser interfacing with the core generator of FIG. 1, in accordance with an aspect of the invention, in accordance with an aspect of the invention;

FIG. 5 shows a system for generating a finished audio output file using the core generator of FIG. 1, in accordance with aspects of the invention;

FIG. 6 shows a system for analysing stems and templates using the language model (LM) described with reference to FIG. 1, in accordance with aspects of the invention;

FIG. 7 shows a system configured to enable a user to select and modify a premade song from the song catalogue database, in accordance with aspects of the invention;

FIG. 8 shows a system for creating or editing video content within an application and synchronizing it with an audio output file from the core generator or the Language Model (LM) of FIG. 1, in accordance with aspects of the invention;

In FIG. 9, a system in which a MIDI-based component is integrated into the system of FIG. 1, to generate hybrid musical works in a closed ecosystem, in accordance with aspects of the invention;

In FIG. 10, a system in which third parties can upload their original works to the system, in accordance with aspects of the invention; and

FIG. 11 shows a computer within which a set of instructions, for causing the computer to perform any one or more of the methodologies described herein, in accordance with aspects of the invention.

### DETAILED DESCRIPTION OF THE DRAWINGS

The following description of the invention is provided as an enabling teaching of the invention. Those skilled in the relevant art will recognize that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptions to the present invention are possible and can even be desirable in certain circumstances and are a part of the present invention. Thus, the following description is provided as illustrative of the principles of the present invention and limitation thereof. The components, relationships, and data flows shown are for example only; other variations may exist that employ similar principles.

Identical reference numerals are consistently used to indicate the same elements in all figures, unless a different numeral is explicitly assigned.

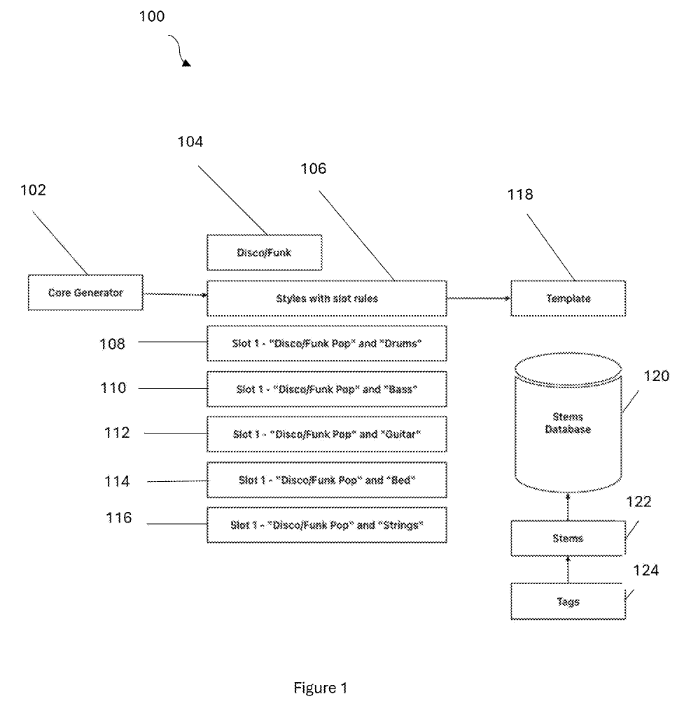

In FIG. 1, a system for generating a hybrid musical work using a computer system, in accordance with an aspect of the invention, is illustrated with reference to numeral 100.

At the core of system 100 is the core generator 102, which manages information related to a specific musical style 104 that the user intends to create music in, exemplified here as “disco/funk.” The musical style 104 is divided into multiple musical slots, each associated with one or more slot rules 106. These slot rules 106 define both the stylistic characteristics (e.g., disco/funk pop) and the corresponding instrument categories (e.g., drums, bass, guitar, strings).

For instance:

Slot 1 (108) pertains to the disco/funk pop style combined with drums.

Slot 2 (110) pertains to the disco/funk pop style combined with bass.

Slot 3 (112) pertains to the disco/funk pop style combined with guitar.

Slot 4 (114) pertains to the disco/funk pop style combined with bed.

Slot 5 (116) pertains to the disco/funk pop style combined with strings.

Additionally, the system 100 incorporates a template module 118, which collaborates with the defined musical styles and slot rules 106 to select appropriate stems 122 from a stems database 120. Each stem 122 is tagged with specific metadata, such as key, tempo, and chord progression, facilitating the determination of compatibility with the selected musical style 104 and its associated slots 108-116.

The core generator 102 thus generates an audio output by combining stems 122 that align with both the predefined musical style 104 and the structural requirements established by the musical templates. This ensures that the resulting composition is harmonically and rhythmically cohesive, adhering to the desired stylistic parameters.

This system 100 leverages human-recorded instrumental stems 122 guided by structured templates, ensuring high-quality and authentic musical outputs. The integration of metadata tagging and template-based selection promotes seamless harmonization and efficient music generation within the defined musical framework.

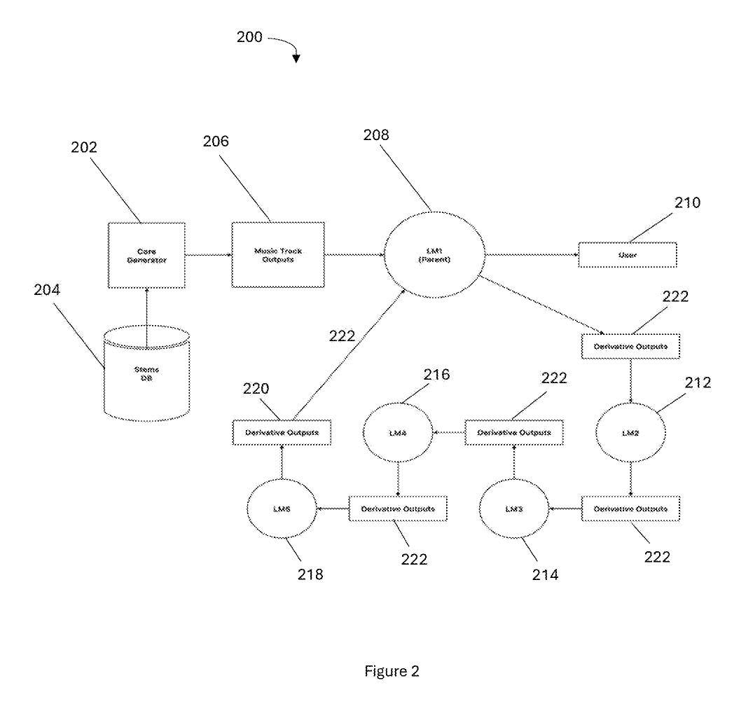

FIG. 2 illustrates a multi-stage daisy-chain learning system 200 for automated music generation and iterative AI refinement, in accordance with an aspect of the invention.

The system 200 leverages a hierarchical structure of interconnected language models (LMs) that process and refine AI-generated musical compositions in multiple stages while maintaining originality and stylistic diversity.

At the foundation of the system 200 is a core generator 202, which retrieves instrumental stems from a stems database (Stems DB) 204 and generates music track outputs 206. These outputs include a complete structured composition, individual instrumental stems, and potentially MIDI representations encoding harmonic and rhythmic structures.

The generated music track outputs 206 are processed by a parent language model (LM1) 208, which serves as the first AI-driven refinement stage. LM1 208 applies initial musical transformations, including adjustments to chord progressions, rhythmic structures, and dynamic variations. The derivative output from LM1 208 is directed to two destinations: it is provided to a user interface 210 for review and customization, and it is also propagated to subsequent AI refinement models for further processing.

The AI-driven refinement process proceeds through a multi-branch daisy-chain structure, where the derivative outputs generated by LM1 are distributed across additional language models, including LM2 212, LM3 214, LM4 216, and LM5 218. Each LM 212, 214, 216 and 218 specializes in distinct aspects of musical transformation.

LM2 212 introduces stylistic modifications tailored to specific genres or harmonic textures, ensuring that the composition aligns with predefined musical conventions. LM3 214 refines the instrumentation, balancing frequency distribution and dynamic coherence to create a well-structured and harmonically rich arrangement. LM4 216 enhances expressive elements, focusing on articulation, phrasing, and tempo variations to add musical nuance and emotional depth. Finally, LM5 218 integrates all previous refinements, synthesizing a polished composition that preserves the creative intent of the original track while incorporating advanced musical attributes and stylistic enhancements.

As depicted in the diagram, each LM in the chain produces derivative outputs 220, which are iteratively improved as they pass through different models. Once LM5218 has processed the composition, its refined output is looped back into LM1 208 through a feedback mechanism 222. This feedback mechanism 222 ensures continuous system learning, preventing model collapse and enabling the AI framework to refine its output progressively over multiple iterations. By reintroducing refined compositions into LM1 208, the system 200 maintains diversity and avoids overfitting, enhancing long-term AI-driven music generation.

The system 200 further incorporates an adaptive scaling module, which dynamically adjusts the number of active LMs based on the complexity of the composition, computational resources, and desired stylistic variations. Additionally, a quality control system is included to evaluate intermediate outputs before they are reintroduced into the daisy-chain cycle, ensuring only high-quality refinements contribute to subsequent AI training iterations.

To provide user customization, the system 200 includes a user interface that allows users to fine-tune various aspects of the AI-driven composition process. This includes adjusting harmonic weightings, instrumental layers, and stylistic attributes to align the AI-generated compositions with specific creative goals.

Furthermore, the system 200 allows for dynamic AI model adaptation, enabling selective freezing, updating, or fine-tuning of individual LMs. This ensures that key musical characteristics remain stable while other aspects evolve based on iterative feedback, maintaining a balance between structured musical integrity and AI-driven innovation.

By integrating a structured core generator 202 with a multi-stage AI refinement process, the system 200 enables sophisticated, scalable, and continuously improving AI-generated music compositions while preserving creative diversity and stylistic authenticity.

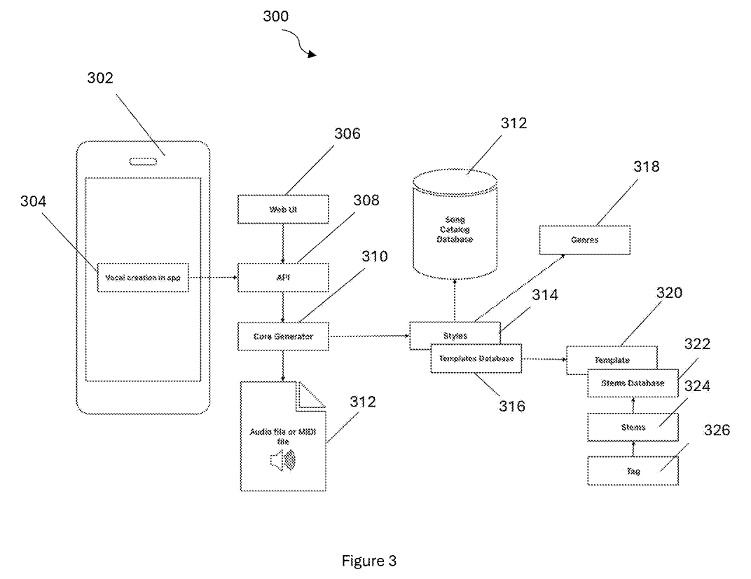

In FIG. 3, a system for integrating musical styles and slots with user inputs, in accordance with an aspect of the invention, is illustrated with reference to numeral 300.

The system 300 comprises a user interface device, such as a mobile phone 302, which includes a vocals app 304 capable of creating or recording vocal tracks.

Additionally, the system 300 features a Web User Interface (Web UI) 306 and an Application Programming Interface (API) 308. These components are responsible for receiving vocals from the vocals app 304 and transmitting them to the core generator 310. The core generator 310 is also capable of handling audio files or MIDI files, allowing for versatile input and output formats.

A key component of the system 300 is the song catalogue database 312, which serves as a comprehensive repository of musical references. This database includes various musical styles 314 and specific genres 318, providing a broad foundation for music generation.

Furthermore, the system 300 incorporates a templates database 316 that links each musical style 314 with specific chord progressions, keys, and instrumentation requirements. This templates database 316 contains numerous templates 322 tailored to different musical configurations.

The system also includes multiple templates 320 that retrieve stems 324 and assign tags 326 from a stems database 320. These tags facilitate the accurate matching of stems to the appropriate templates based on their musical characteristics such as key, tempo, and chord progression. By utilizing the templates database 316 and the stems database 320, the core generator 310 can produce coherent musical outputs that align with the selected musical styles, defined slots, and user-provided vocals or instrumental recordings.

The integration of these databases and interfaces enables the core generator 310 to generate harmonious and rhythmically consistent audio outputs. The system 300 ensures that each musical composition adheres to the predefined structural and stylistic parameters, resulting in high-quality and artistically aligned musical works.

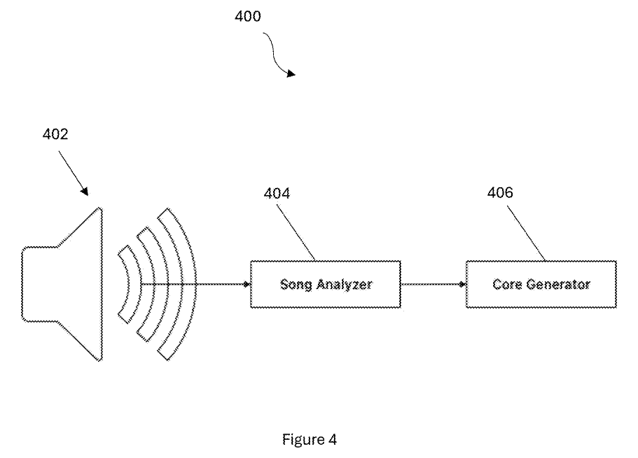

In FIG. 4, a simplified version of a song analyser interfacing with the core generator of FIG. 1 is illustrated with reference to numeral 400, in accordance with an aspect of the invention.

In this embodiment, the audio analyser 404 receives an audio input 402, which can originate from sources such as a speaker signal or a digital audio file. The audio analyser 404 processes this input to determine key musical attributes, including tempo, key, chord progression, and style indicators. These attributes are essential for understanding the structural and stylistic elements of the existing track.

Once the analysis is complete, the song analyser 404 transmits its findings to the core generator 406. The core generator 406 utilizes the identified musical attributes to apply the appropriate musical framework or style rules, enabling it to selectively combine relevant instrument content blocks (stems) or to construct new musical arrangements. This process ensures that the generated music adheres to the desired stylistic and harmonic standards defined by the templates and slot rules established within the system.

This configuration allows a user to upload an existing track for purposes such as remixing or adaptation, leveraging the system's ability to recognize and utilize specific musical features. By analysing the uploaded track's musical characteristics, the system 300 can seamlessly integrate new instrument stems or rearrange existing ones to create a refreshed version of the original composition. This functionality supports the creation of high-quality, harmonically coherent musical works that respect the original style while introducing innovative variations.

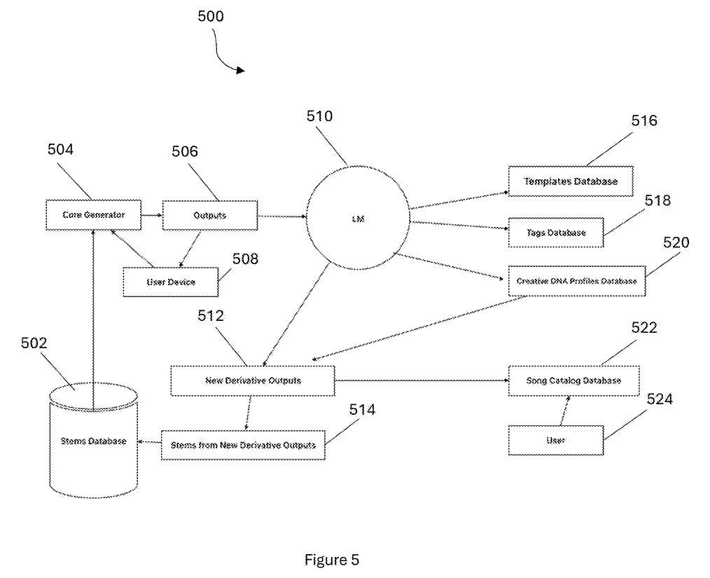

In FIG. 5, a system for generating a finished audio output file using the core generator of FIG. 1, in accordance with an aspect of the invention, is illustrated with reference to numeral 500.

The system 500 comprises several key components, namely: a stems database 502, a core generator 504, various outputs 506, a user device 508, a language model (LM) 510, new derivative outputs 512, stems from new derivative outputs 514, templates database 516, tags database 518, creative DNA profiles database 520, song catalogue database 522, and user 524.

A user 524 interacts with the system 500 through a user device 508, which allows them to input preferences and upload or modify audio content.

FIG. 4 illustrates the continuous feedback loop within the system 500, where the LM 510 communicates with the templates database 516, tags database 518, stems database 502, and creative DNA profiles database 520. By continuously ingesting user-generated outputs and derivative works, the system 500 refines its music generation capabilities. This process expands the repertoire of stems and templates internally, eliminating the need for external, unlicensed datasets and ensuring full ethical compliance.

More particularly, the stems database 502 stores individual instrument stems and vocal content blocks, each tagged with relevant metadata such as tempo, key, and chord progression. The core generator 504 creates the final audio output by combining selected stems based on user preferences or automated prompts from the LM 510. The resulting audio or MIDI files are referred to as outputs 506.

The LM 510 enhances the system's music generation capabilities by processing existing outputs to generate new derivative outputs 512. These new compositions 512 are broken down into individual stems 514, which are then fed back into the stems database 502. The templates database 516 stores musical templates associated with each derivative output, defining specific chord progressions, keys, and tempos, while the tags database 518 contains tags describing the musical attributes of each stem 514 and template, facilitating accurate matching and retrieval. To ensure proper recognition and attribution, the creative DNA profiles database 520 maintains profiles that attribute each derivative output to the original creators.

Additionally, the song catalogue database 522 serves as a repository of comprehensive musical references, including various musical styles 314 and specific genres 318.

The system 500 executes the core generator 504 and interfaces with multiple databases, including the stems database 502, templates database 516, tags database 518, and creative DNA profiles database 520. When the core generator 504 produces a finished audio output file 506 based on user input or automated prompts, a copy of this output is sent to the LM 510 for training purposes.

The LM 510 processes the audio output file 506 to generate new derivative outputs 512. These new derivative outputs 512 are then decomposed via a decomposition module into individual stems 514, which are reintegrated into the stems database 502. In some embodiments, the decomposition of individual stems 514 may be provided via a specific decomposition module (not shown). Alternatively, the decomposition may be provided by a virtual ‘decomposition module’ which is part of the language model 510 or another component of the overall system architecture. Concurrently, new musical templates associated with these derivative outputs are stored in the templates database 516, while any newly identified tags or attributes are added to the tags database 518. Additionally, creative DNA profiles are assigned to each new derivative output 512 and stored in the creative DNA profiles database 520, ensuring that each contributor’s role is accurately tracked and attributed.

The integration of these components allows the core generator 504 to produce coherent and harmonically aligned musical outputs that respect the selected styles and user-provided inputs. The system 500 leverages human-recorded stems and advanced AI-driven continuous learning to maintain high-quality, authentic, and original music generation while ensuring proper attribution and legal compliance.

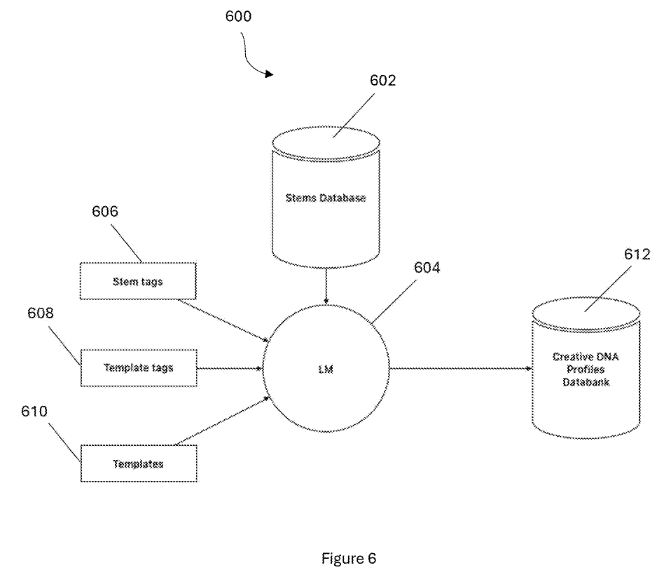

FIG. 6 outlines a system for of generating an audio output file via a computer system, in accordance with aspects of the invention.

In FIG. 6, a system for analysing stems and templates using the language model (LM) described with reference to FIG. 1, in accordance with an aspect of the invention, is illustrated with reference to numeral 600.

The system 600 comprises several key components: a stems database 602, a Language Model (LM) 604, stems tags 606, template tags 608, templates 610, and a creative DNA profiles databank 612.

In this embodiment, stems 602 and templates 610 are provided to the LM 604 for analysis. The LM 604 processes the stems 602 to generate a “creative DNA” profile for each stem 606. These creative DNA profiles are then stored in the creative DNA profiles databank 612 for attribution purposes, ensuring that each stem’s origin and associated metadata are accurately recorded and traceable.

The LM 604 utilizes stems tags 606 and template tags 608 to identify and categorize the musical attributes of each stem and template. This categorization facilitates accurate matching and retrieval, enabling the core generator 604 to select appropriate stems and templates that align with the desired musical style and structure. By analysing the stems and templates, the LM 604 enhances the system's ability to generate harmonically coherent and stylistically consistent musical outputs.

Furthermore, the creative DNA profiles databank 612 not only ensures proper recognition and attribution of original creators but also contributes to the system's adaptive learning process. As new stems and templates are analysed and their creative DNA profiles are generated, the system continuously updates its databases, allowing for more refined and personalized music generation over time. This iterative improvement cycle enhances the system's capability to produce high-quality, original compositions that respect the creative contributions of individual musicians.

Additionally, the integration of the creative DNA profiles with the song catalogue database 522 allows the system 600 to reference and build upon a rich repository of musical styles and genres 318. This comprehensive referencing ensures that the system 600 can accommodate a wide range of musical preferences and trends, maintaining relevance and adaptability in dynamic music production environments.

Overall, the system 600 leverages the language model 604 and creative DNA profiles databank 612 to maintain an organized and ethically compliant framework for music generation. This framework not only supports the accurate attribution of creative works but also enhances the system's ability to generate innovative and high-quality musical outputs by continuously learning from user-generated content and derivative works.

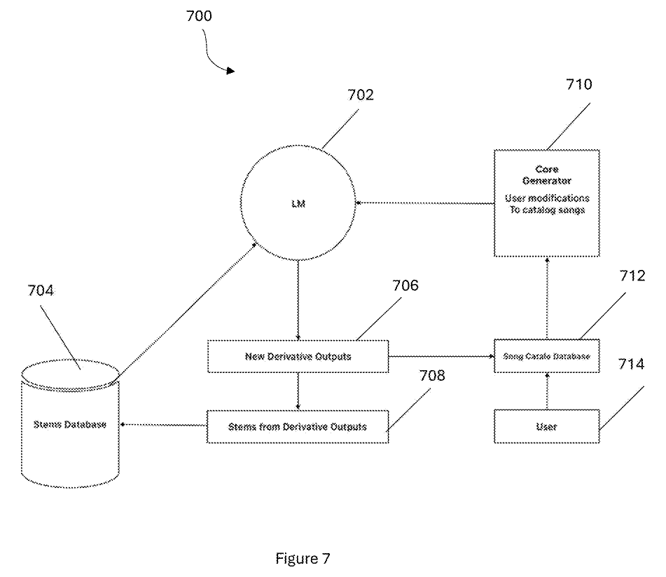

In FIG. 7, a system configured to enable a user to select and modify a premade song from the song catalogue database, in accordance with an aspect of the invention, is depicted with reference to numeral 700.

The system 700 comprises several key components: a language model (LM) 702, a stems database 704, new derivative outputs 706, stems from derivative outputs 708, a core generator 710 for user modifications to catalogue songs, a song catalogue database 712, and a user 714.

In this embodiment, the user 714 begins by selecting a premade song from the song catalogue database 712. The selected song is then loaded into the core generator 610, where the user can modify it according to their preferences. These modifications may include altering specific instrument stems, adjusting the tempo, changing the key, or rearranging sections of the song. Once the user has made the desired changes, the updated song is forwarded to the language model (LM) 702 for training.

Based on these user-driven changes, the LM 702 generates new derivative outputs 706. These new compositions 706 are subsequently broken down into individual stems 608, which are then stored back into the stems database 704. This process ensures that the stems database 704 continually evolves with new content derived from user modifications.

Additionally, any modifications or expansions made within the core generator 710 are catalogued back into the song catalogue database 712. This integration allows for iterative, user-led enhancements, enabling users to build upon previous work while maintaining a comprehensive record of each modification step. By doing so, the system 700 supports continuous improvement and personalization of musical compositions, fostering a dynamic and user-centric music creation environment.

This workflow exemplifies how the system leverages user interactions to enhance the language model's training data, thereby refining the system's music generation capabilities. The closed-loop process ensures that each user modification contributes to the system's growing repository of stems and templates, promoting both scalability and ethical compliance by relying solely on internally generated and user-provided content.

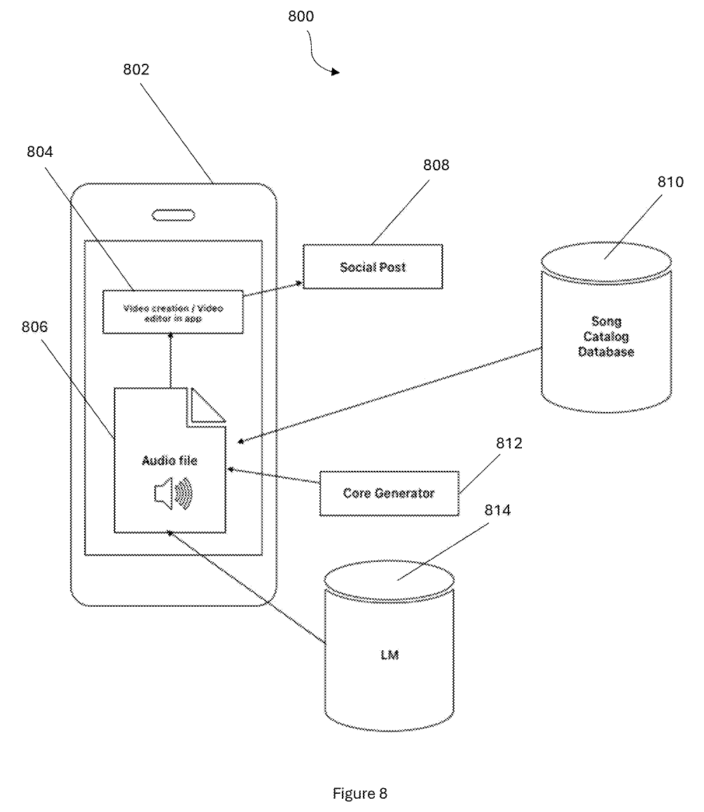

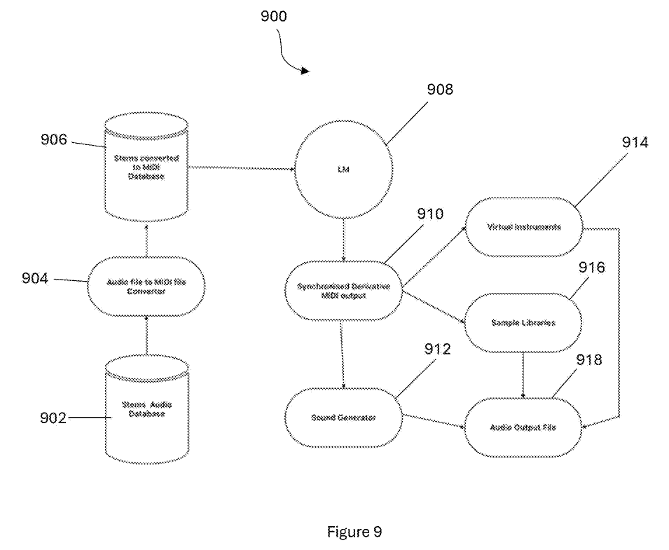

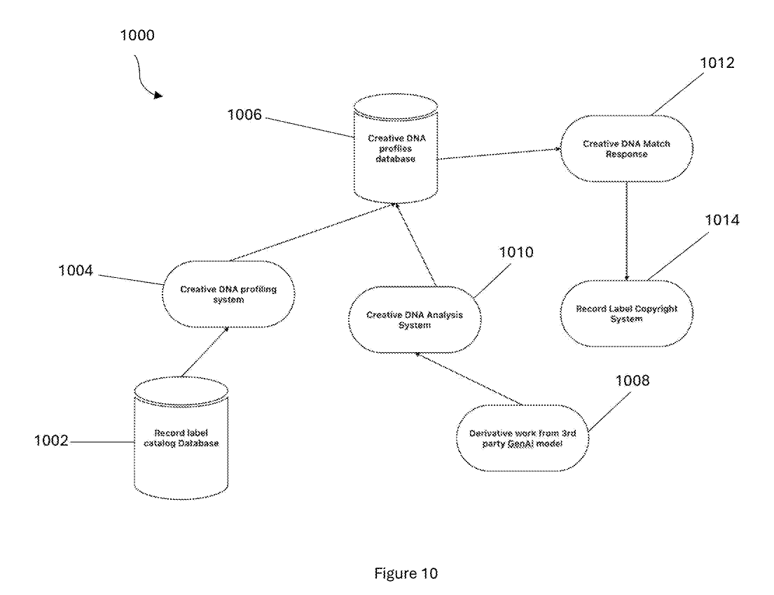

In FIG. 8, a system for creating or editing video content within an application and synchronizing it with an audio output file from the core generator or the Language Model (LM) of FIG. 1, is illustrated with reference to numeral 800.

The system 800 includes several key components: a mobile device such as a mobile phone 802, a video creation or video editing app 804, an audio file 806, a social post 708, a song catalogue database 810, a core generator 812, and a language model (LM) 814.

A user 714 interacts with the system through the mobile device 802, using the video editing app 804 to create or modify video content. The video editing app 804 integrates with the core generator 812 and the LM 814 to synchronize the video with an audio file 806. This audio file 806 may originate from the core generator 812 or be generated by the LM 814 based on user inputs and preferences.

The system 800 references the song catalogue database 810 to select appropriate musical styles and templates that enhance the video content. The video editing app 804 provides tools such as cropping and special effects, enabling users to refine their video productions while ensuring that the audio and visual elements are harmoniously aligned.

Once the user finalizes the video-and-music composition, the system 800 allows the user to post the final product as a social post 808 to various social media platforms. This capability creates an integrated environment that combines ai-driven music creation with multimedia editing and social sharing, providing a streamlined workflow for content creators.

Through this integration, the system 800 enables the creation of high-quality, synchronized audio-visual content, enhancing the user experience by merging advanced music generation with robust video editing tools and seamless social media connectivity.

In FIG. 9, a system in which a MIDI-based component is integrated into the system of FIG. 1, to generate hybrid musical works in a closed ecosystem, is illustrated with reference to numeral 900.

In this embodiment, audio stems 900 are fed from a stems audio database 902 into an audio-to-MIDI conversion system 904. Using advanced transcription algorithms, each audio stem is converted into a corresponding MIDI file, capturing key musical attributes such as pitch, velocity, timing, and note duration. These newly created MIDI files are then stored in a MIDI stems database 906, along with metadata that links them back to the original audio stems.

Once in MIDI form, the system 900 can perform ongoing, real-time manipulations of these MIDI files, enabling real-time reassignment of notes, key, chords, tempo, and rhythm to generate derivative works.

As shown in FIG. 9, multiple MIDI stems —some of which may have originated from unrelated audio stems—can be synchronized and layered to form cohesive, harmonically blended new arrangements. The language model (LM) 908 receives these MIDI files to learn from their structure and context, allowing it to generate further derivative MIDI outputs.

By harmonically reassigning notes, adapting chord progressions, and unifying tempo and rhythm, the LM 908 ensures that MIDI stems originating from different template structures are musically compatible, ultimately producing new, synchronised derivative MIDI files 910 as an output. These derivative MIDI files 910 can be fed to a sound generator 912, virtual instruments 914, or sample libraries 916 to produce high-quality audio output 918. This audio output 918 retains a traceable lineage to its original input sources.

This dual-input approach—using both audio stems and their corresponding MIDI files—offers substantial flexibility, since any final musical composition can be rendered from MIDI in numerous ways (e.g., by changing instruments, applying different sample libraries, or shifting style parameters). The ability to continuously feed newly generated MIDI arrangements back into the language model (LM) 908 not only refines AI-driven music creation but also maintains clear traceability for copyright protection, ensuring that every derivative work is attributed and catalogued in the system’s metadata framework.

In FIG. 10, a system in which third parties can upload their original works to the system, is illustrated with reference to numeral 1000.

More particularly, FIG. 10 illustrates a system 1000 in which third parties, such as record labels, artists, or rights holders, can upload their original works to generate and store unique DNA profiles. As shown, these works are first submitted to a record label catalog database 1002. They are then processed by a creative DNA profiling system 1004, which produces a unique “creative DNA” or “fingerprint” for each work, subsequently stored in a creative DNA profiles database 1006 for future reference and matching.

Third parties can also upload new derivative works—for instance, AI-generated compositions from external platforms such as Suno™ or Udio™—through a third-party AI model 908. Each such derivative work is automatically cross-referenced against the existing DNA profiles in the database 1006 by a creative DNA analysis system 1010. This analysis yields a creative DNA match response 1012, whose output is then provided to a record label copyright system 1014. By detecting DNA traces linking the derivative works back to original copyrighted material in the record label catalog database 1002, the system 1000 ensures that copyright owners retain visibility and intellectual property protection.

A key advantage of this approach is that the system’s lineage detection does not rely on third-party AI models 1008 being pre-trained on any encrypted data or DNA profiles. Instead, the system 1000 employs a robust post-generation analysis able to identify and flag copyrighted elements regardless of how or when the AI model was trained. Consequently, rights holders can verify potential infringement or unauthorized usage even if the AI training dataset never contained the original works. Upon a positive detection of creative lineage, the system 1000 can generate notifications or flags 1014 to inform copyright owners, enabling them to take enforcement or licensing action as appropriate.

By linking each derivative work to its creative DNA signature, the system 1000 fosters accountability, secures provenance, and facilitates ethically compliant AI-generated music ecosystems that respect the intellectual property rights of creators, labels, and artists.

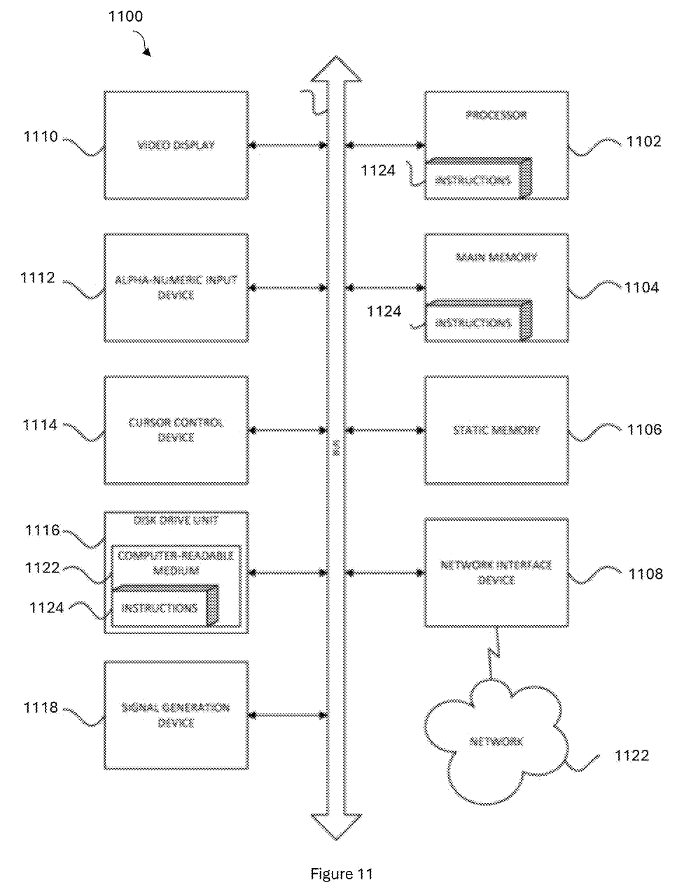

In FIG. 11, a computer within which a set of instructions, for causing the computer to perform any one or more of the methodologies described herein, may be executed. In accordance with embodiments of the invention, the computer is generally described with reference to numeral 1100.

According to some embodiments, a computer 1100 is disclosed which comprises: one or more processors; and a non-transitory computer-readable memory having stored therein computer-executable instructions, that when executed by the one or more processors, cause the one or more processors to perform actions comprising: recording one or more instrumental stems using structured musical templates, selecting one or more of the recorded instrumental stems to combine into a coherent musical work, feeding the resulting musical work and the original instrumental stems into a generative Artificial Intelligence AI model, and upon the AI model combining the resulting musical work and the original instrumental stems into a novel derivative work, reintroducing the novel derivative work into the AI model iteratively, thereby facilitating continuous learning and improvement of the AI model to produce a continuously improved hybrid musical work.

In a networked deployment, the computer 1100 may operate in the capacity of a server or a client machine in server-client network environment, or as a peer machine in a peer-to-peer (or distributed) network environment. The computer 1100 may be a personal computer (PC), a tablet PC, a set-top box (STB), a Personal Digital Assistant (PDA), a cellular telephone, a web appliance, a network router, switch or bridge, or any computer 1000 capable of executing a set of instructions (sequential or otherwise) that specify actions to be taken by that computer 1100. Further, while only a single computer 1100 is illustrated, the term "computer" shall also be taken to include any collection of computers that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer 1100 may further include a video display unit 1110 (e.g., a liquid crystal display (LCD)). The computer 1100 also includes an alphanumeric input device 1112 (e.g., a keyboard), a user interface (Ul) navigation device 1114 (e.g., a mouse), a disk drive unit 1116, a signal generation device 1118 (e.g., a speaker) and a network interface device 1120.

The disk drive unit 1116 includes a computer-readable medium 1122 on which is stored one or more sets of instructions and data structures (e.g., software 1124) embodying or utilizing any one or more of the methodologies or functions described herein. The software 1124 may also reside, completely or at least partially, within the main memory 1104 and/or within the processor during execution thereof by the computer system 1100, the main memory and the processor also constituting computer-readable media. To this end, for clarity, please note that where the software 1124 is not located in the main memory 1104 and/or within the processor during execution thereof by the computer system 1100, it will be in a cloud-based or remote storage location and may be executed directly from there.

The software 1124 may further be transmitted or received over a network 1126 via the network interface device 1120 utilizing any one of several well-known transfer protocols (e.g., HTTP, FTP).

In some embodiments the computer-readable medium 1122 for carrying out the above-mentioned technical steps of the framework’s functionality, is non-transitory in nature. The non-transitory computer-readable medium 1122 has tangibly stored thereon, or tangibly encoded thereon, software 1124 that when executed by a device (e.g., application server, messaging server, email server, ad server, content server and/or client device, and the like) cause at least one processor to perform a method for generating a hybrid musical work in a closed ecosystem. In accordance with one or more embodiments, a system is provided that comprises one or more computer systems 1000 configured to provide functionality in accordance with such embodiments. In accordance with one or more embodiments, functionality is embodied in steps of a method performed by at least one computer. In accordance with one or more embodiments, software 1124, program code (or program logic) executed by a processor(s) of a computer system 1100 to implement functionality in accordance with one or more such embodiments are embodied in, by and/or on a non-transitory computer-readable medium 1122.

While the computer-readable medium 1122 is shown in an example embodiment to be a single medium, the term "computer-readable medium" should be taken to include a single medium or multiple media (e.g., a centralized or distributed database, and/or associated caches and servers) that store the one or more sets of instructions. The term "computer-readable medium" shall also be taken to include any medium that is capable of storing, encoding or carrying a set of instructions for execution by the computer system 1000 and that cause the computer system 1100 to perform any one or more of the methodologies of the present embodiments, or that is capable of storing, encoding or carrying data structures utilized by or associated with such a set of instructions. The term "computer-readable medium" shall accordingly be taken to include, but not be limited to, solid-state memories and optical and magnetic media as well as cloud storage options (such as Amazon Webservices TM, Microsoft Azure TM, and the like).

1. A computer-implemented system for generating musical works, comprising:
a stems database, configured to store a plurality of musical stems, wherein each musical stem is tagged with metadata describing musical attributes;
a templates database, configured to store a plurality of musical templates, wherein each musical template defines structural parameters for combining musical stems;
a core generator which is in communication with the stems database and templates database, and which is configured to combine selected musical stems from the stems database, according to structural parameters of one or more musical templates from the templates database, thereby generating an output file;
an artificial intelligence model, configured to process the output file generated by the core generator, and to generate one or more derivative outputs therefrom;
a decomposition module, configured to analyse one or more derivative outputs generated by the artificial intelligence model, and to extract a plurality of derivative musical stems therefrom; and
wherein the system is configured to send the extracted derivative musical stems to be stored in the stems database, wherein the extracted derivative musical stems are available for use in subsequent music generation processes.

2. The computer-implemented system as claimed in claim 1, wherein the musical stems and the output file are audio format files, or MIDI files.

3. The computer-implemented system as claimed in claim 1, wherein the musical stems comprise at least one of individual instrument stems and vocal content blocks.

4. The computer-implemented system as claimed in claim 1, wherein each musical stem is tagged with metadata including one or more of: tempo, key, chord progression, instrument type, and musical style.

5. The computer-implemented system as claimed in claim 1, wherein:
the stems database is configured to receive and store derivative stems extracted by the decomposition module, thereby expanding the repertoire of stems available for subsequent music generation processes; and
the templates database is configured to store new musical templates associated with the derivative output of the artificial intelligence model, thereby expanding the repertoire of musical templates available for subsequent music generation processes.

6. The computer-implemented system as claimed in claim 1, further comprising a tags database, configured to store metadata describing musical attributes of the extracted derivative musical stems and musical templates.

7. The computer-implemented system as claimed in claim 6, wherein the tags database is configured to store newly identified tags or attributes associated with the derivative output.

8. The computer-implemented system as claimed in claim 1, wherein the core generator is configured to combine compatible musical stems based on the metadata associated with each musical stem.

9. The computer-implemented system as claimed in claim 1, wherein the core generator is configured to combine selected musical stems based on an automated prompt from the artificial intelligence model.

10. The computer-implemented system as claimed in claim 1, further comprising a user interface which is configured to allow a user to input preferences and upload or modify musical content, and wherein the core generator is configured to combine selected musical stems based on user preferences input via the user interface.

11. The computer-implemented system as claimed in claim 1, wherein the musical templates stored in the templates database define one or more of: chord progressions, keys, tempos, and instrumentation requirements.

12. The computer-implemented system as claimed in claim 1, wherein the core generator is configured to select musical stems, based on matching of metadata associated with said musical stems to the structural parameters defined in the musical templates, thereby providing harmonic and rhythmic compatibility between the selected musical stems.

13. The computer-implemented system as claimed in claim 1, wherein the artificial intelligence model comprises a plurality of language models arranged in a sequential chain, wherein each language model is configured to refine one or more aspects of the output file.

14. The computer-implemented system as claimed in claim 13, wherein the artificial intelligence model comprises at least two language models.

15. The computer-implemented system of claim 13, further comprising a feedback mechanism configured to feed an output of a final language model in the sequential chain back to a parent language model.

16. The computer-implemented system of claim 13, wherein the plurality of language models includes:
a parent language model configured to apply initial musical transformations to the output file, including one or more of adjustments to chord progressions, rhythmic structures, and dynamic variations;
a first language model configured to introduce stylistic modifications to the output file, said stylistic modifications tailored to specific genres or harmonic textures;
a second language model configured to refine instrumentation of the output file, to balance frequency distribution and dynamic coherence;
a third language model configured to refine articulation, phrasing, and tempo variations of the output file; and
a fourth language model, configured to integrate the refinements of the first, second and third language models to synthesize an adjusted audio output.

17. The computer-implemented system as claimed in claim 1, wherein the artificial intelligence model is configured to analyse musical stems to generate a creative DNA profile for each musical stem.

18. The computer-implemented system as claimed in claim 1, further comprising a creative DNA profile database configured to store a creative DNA profile for each musical stem and each derivative output.

19. The computer-implemented system as claimed in claim 18, wherein the creative DNA profile database is configured to store attribution data linking each derivative output to one or more creators of the musical stems used to generate said derivative output.

20. The computer-implemented system as claimed in claim 1, wherein the system is configured to operate within a closed ecosystem, using only musical stems generated internally by the system or musical stems uploaded by a user.

21. The computer-implemented system as claimed in claim 1, wherein the decomposition module is configured to associate the extracted derivative stems with metadata describing musical attributes of said derivative stems.

22. The computer-implemented system as claimed in claim 21, wherein the metadata associated with the extracted derivative stems comprises one or more of tempo, key, chord progression, instrument type, and musical style.

23. The computer-implemented system as claimed in claim 1, further comprising an audio-to-MIDI conversion system configured to convert one or more musical stems from audio format to MIDI format.

24. The computer-implemented system as claimed in claim 23, wherein the artificial intelligence model is configured to process MIDI format musical stems to generate derivative MIDI outputs.

25. A method for generating musical works via a computer-implemented system, the method comprising:
storing, via a stems database, a plurality of musical stems, wherein each musical stem is tagged with metadata describing musical attributes;
storing, via a templates database, a plurality of musical templates, wherein each musical template defines structural parameters for combining musical stems;
selecting and combining a plurality of compatible musical stems from the stems database, according to one or more musical templates;
generating, via a core generator, an output file;
processing the generated output file, via an artificial intelligence model, in order to generate one or more derivative outputs;
decomposing the one or more derivative outputs, via a decomposition module, to extract a plurality of derivative musical stems; and
storing the plurality of derivative musical stems in the stems database, wherein the extracted derivative musical stems are available for use in subsequent music generation processes.

26. The method for generating musical works as claimed in claim 25, further comprising:
storing derivative stems extracted by the decomposition module in the stems database, to expand the repertoire of stems available for subsequent music generation processes; and
storing new musical templates associated with the derivative output of the artificial intelligence model in the templates database, to expand the repertoire of musical templates available for subsequent music generation processes.

27. The method for generating musical works as claimed in claim 25, further comprising storing metadata describing musical attributes of the extracted derivative musical stems and musical templates in a tags database.

28. The method for generating musical works as claimed in claim 27, comprising storing newly identified tags or attributes associated with the derivative output in the tags database.

29. The method for generating musical works as claimed in claim 25, further comprising combining, via the core generator, compatible musical stems based on the metadata associated with each stem.

30. The method for generating musical works as claimed in claim 25, further comprising combining, via the core generator, selected musical stems based on an automated prompt from the artificial intelligence model.

31. The method for generating musical works as claimed in claim 25, further comprising:
inputting, via a user interface, input preferences and, optionally, uploading or modifying musical content, via the user interface;
combining, via the core generator, selected musical stems based on user preferences input via the user interface.

32. The method for generating musical works as claimed in claim 25, further comprising selecting musical stems, via the core generator, based on matching of metadata associated with said musical stems to the structural parameters defined in the musical templates.

33. The method for generating musical works as claimed in claim 25, wherein the artificial model comprises a plurality of language models arranged in a sequential chain, and wherein the method further comprises refining, via a plurality of language models, one or more aspects of the output file.

34. The method for generating musical works as claimed in claim 33, comprising feeding an output of a final language model in the sequential chain back to a parent language model, via a feedback mechanism.

35. The method for generating musical works as claimed in claim 34, further comprising:
applying, via a parent language model, one or more initial musical transformations to the output file, including one or more of adjustments to chord progressions, rhythmic structures, and dynamic variations;
receiving, at a first language model, a modified output from the parent language model and introducing stylistic modifications to said modified output, via the first language model, wherein said stylistic modifications are tailored to specific genres or harmonic textures;
receiving, at a second language model, a modified output from the first language model and refining the instrumentation of said modified output, via the second language model, to balance frequency distribution and dynamic coherence;
receiving, at a third language model, a modified output from the second language model and refining the articulation, phrasing, and tempo variations of said modified output, via the third language model;
receiving, at a fourth language model, a modified output from the third language model and integrating the refinements of the first, second and third language models to synthesize an adjusted audio output, via the fourth language model; and
sending the adjusted audio output to the parent language model, via a feedback mechanism.

36. The method for generating musical works as claimed in claim 25, comprising analysing, via the artificial intelligence model, musical stems to generate a creative DNA profile for each musical stem.

37. The method for generating musical works as claimed in claim 25, wherein the system further comprises a creative DNA profile database and wherein the method comprises:
storing a creative DNA profile for each musical stem and each derivative output in the creative DNA profile database.

38. The method for generating musical works as claimed in claim 37, comprising storing attribution data in the creative DNA profile database, wherein said attribution data links each derivative output to one or more creators of the musical stems used to generate said derivative output.

39. The method for generating musical works as claimed in claim 25, comprising generating, via the core generator, the output file using only musical stems generated internally by the system or musical stems uploaded by a user.

40. The method for generating musical works as claimed in claim 25, comprising associating, via the decomposition module, extracted derivative stems with metadata describing musical attributes of said derivative stems.

41. The method for generating musical works as claimed in claim 25, comprising converting one or more musical stems from an audio format to a MIDI format, via an audio-to-MIDI conversion system; and, optionally, processing MIDI format musical stems to generate derivative MIDI outputs, via the artificial intelligence model.
